(19) United States
(12) Patent Application Publication
(10) Pub. No.: US 2009/0183794 A1
(43) Pub. Date: Jul. 23, 2009

(54) Lateral pipe lining material and lateral pipe lining method

(75) Inventors: Takao Kamiyama, Hiratsuka-shi (JP); Koji Kaneta, Hiratsuka-shi (JP); Kenji Fujii, Hiratsuka-shi (JP)

Correspondence Address: BRUCE L. ADAMS, ESQ.;ADAMS & WILKS, SUITE 1231, 17 BATTERY PLACE, NEW YORK, NY, 10004, US

(73) Assignee: SHONAN GOSEI-JUSHI SEISAKUSHO K.K.

(21) Appl. No.: 12/321,541

(22) Filed: Jan. 22, 2009

(30) Foreign Application Priority Data
Jan. 23, 2008 (JP) 2008-012331

(51) Int. Cl. F16L 55/16

(52) U.S. Cl. 138/98; 138/97; 405/184.2; 405/150.1

(57) ABSTRACT

A lateral pipe lining material having a tubular resin-absorbing material impregnated with a thermosetting resin is inserted through a main pipe into the lateral pipe. The lateral pipe lining material is provided with a pushing-up member to push up a collar formed at its end of the lateral pipe lining material. When the lateral pipe lining material is drawn into the lateral pipe to the extent that the collar reaches an opening of the lateral pipe, the pushing-up member is lifted to bring the collar into close contact with the lateral pipe opening periphery of the main pipe. The lateral pipe lining material is then expanded and a heating medium is applied thereto to cure the resin impregnated in the tubular resin-absorbing material. The lateral pipe lining material can be drawn smoothly into the lateral pipe even when it is bent, enabling the lateral pipe to be lined with a high quality.

### BACKGROUND OF THE INVENTION

1. Field of the Invention

The present invention relates to a lateral pipe lining material and a lateral pipe lining method, and more particularly to the lateral pipe lining material to repair a lateral pipe extending from a main pipe toward the ground and to the lateral pipe lining method for lining the lateral pipe using the lateral pipe lining material.

2. Description of the Related Art

Conventionally, pipe lining methods used when a pipe such as a sewer pipe or the like buried under the ground is aged have been known which repair the pipe by performing lining on its inner circumferential surface without digging up the pipe from underground.

For example, Japanese Patent Application Laid-open No. 1992-355115 discloses a method for lining a lateral pipe that branches off from a main pipe, wherein a collar formed at an end of a lateral pipe lining material that is placed inside a pressure bag is set on a set nozzle of a working robot introduced in the main pipe and the collar is brought into close contact with a lateral pipe opening periphery of the main pipe when the lateral pipe lining material is to be inserted to the lateral pipe. When compressed air is supplied in the pressure bag, it sequentially everts and inserts the lateral pipe lining material into the lateral pipe toward the ground. After the lateral pipe lining material has been everted and inserted through the entire length thereof, the lining material is pressed against the inner circumferential surface of the lateral pipe and heated in order to cure the lateral pipe lining material to repair the inner circumferential surface of the lateral pipe. After the curing of the lateral pipe lining material is complete, portions of the everted lateral pipe lining material protruding into a box opened to the ground are cut off and the working robot together with the pressure bag is pulled out of the main pipe, thus completing a series of processes of the lateral pipe lining.

However, the above conventional method has drawbacks. That is, in the above conventional lateral pipe lining method, it is necessary that the working robot is introduced in the main pipe to set the collar of the lateral pipe lining material at a location at which the main pipe intersects with the lateral pipe, which requires much time and labor. Moreover, compressed air is used to evert and insert the lateral pipe lining material into the lateral pipe from the main pipe toward the ground. This disadvantageously necessitates a pressure bag for everting the lateral pipe lining material. To solve these problems, many lining methods have been proposed in which a lateral pipe lining material is pulled from the aboveground level into the lateral pipe through the main pipe using a pulling rope (for example, see Japanese Patent Application Laid-open No. 2007-253509).

However, another problem arises if the lateral pipe extends from the main pipe and is bent on the way to the ground. When the lateral pipe lining material is pulled aboveground, the bent portions of the lateral pipe interfere with good close contact between the collar of the lateral pipe lining material and the lateral pipe opening periphery of the main pipe, thus causing a lining failure. Particularly, high degree of bending of the lateral pipe or a large number of times of the bending causes the serious problem.

Still another problem is that, if the degree of bending of the lateral pipe is high or the number of times of the bending is large, wrinkles occur in the resin impregnated in the lateral pipe lining material, thereby making it impossible to achieve uniform lining.

### SUMMARY OF THE INVENTION

It is an object of the present invention to provide a lateral pipe lining material and a lateral pipe lining method which are capable of excellently drawing the lateral pipe lining material into a lateral pipe to perform high-quality lining of the lateral pipe.

A lateral pipe lining material according to the present invention is inserted into a lateral pipe having an opening at a location where the lateral pipe communicates with a main pipe. The lateral pipe lining material comprises a tubular resin-absorbing material that is impregnated with a setting resin; a collar formed at an end of the tubular resin-absorbing material; and a pushing-up member for pushing up the collar so as to come into close contact with a lateral pipe opening periphery of the main pipe when the lateral pipe lining material is inserted into the lateral pipe.

A lateral pipe lining method according to the present invention is adapted for use in lining a lateral pipe. A tubular lateral pipe lining material having a collar formed at an end of a tubular resin-absorbing material impregnated with a setting resin is inserted through a main pipe into the lateral pipe via an opening of the lateral pipe at which the lateral pipe communicates with the main pipe. The method comprises the steps of attaching to the lateral pipe lining material a pushing-up member for pushing up the collar of the lateral pipe lining material; drawing the lateral pipe lining material from an aboveground position into the main pipe using a drawing rope; lifting the pushing-up member in the aboveground direction to bring the collar of the lateral pipe lining material into close contact with a lateral pipe opening periphery of the main pipe when the lateral pipe lining material is drawn into the lateral pipe to the extent that the collar thereof reaches the lateral pipe opening periphery of the main pipe; expanding the lateral pipe lining material against the inner circumferential surface of the lateral pipe, the collar of the lateral pipe lining material being in close contact with the lateral pipe opening periphery of the main pipe by means of the pushing-up member; and supplying a heating medium to the expanded lateral pipe lining material to cure a resin impregnated in the tubular resin-absorbing material and line the lateral pipe.

A lateral pipe lining method according to the present invention also comprises the steps of drawing the lateral pipe lining material into the lateral pipe from an aboveground position using a drawing rope; sealing the aperture of the collar of the lateral pipe lining material when it is drawn into the lateral pipe to the extent that the collar of the lateral pipe lining material comes into close contact with the lateral pipe opening periphery of the main pipe; expanding the lateral pipe lining material against the inner circumferential surface of the lateral pipe and supplying a heating medium in the expanded lateral pipe lining material to start curing the resin impregnated therein; inserting an expandable wrinkle pressing-out tool into the lateral pipe lining material before the resin impregnated in the lateral pipe lining material has been cured completely; expanding the wrinkle pressing-out tool against the tubular resin-absorbing material; and moving the wrinkle pressing-out tool to press out wrinkles in the resin and line the lateral pipe.

According to the invention, the collar of the lateral pipe lining member is pushed up by the pushing-up member and brought into close contact with the lateral pipe opening periphery of the main pipe, thus allowing a high-quality lateral pipe lining to be realized.

Furthermore, even when the bent lateral pipe causes wrinkles to be generated in a resin impregnated in the tubular resin absorbing material, the wrinkles can be easily pressed out by the simple configuration, whereby uniform lining can be performed on the lateral pipe.

### BRIEF DESCRIPTION OF THE DRAWINGS

The above and other objects, advantages, and features of the present invention will be more apparent from the following description taken in conjunction with the accompanying drawings in which:

FIG. 1 is an illustrative view showing a state where a lateral pipe lining material is drawn into a lateral pipe according to an embodiment of the present invention;

FIG. 2a is a perspective view showing one embodiment of the lateral pipe lining material;

FIG. 2b is a cross-sectional view of the lateral pipe lining material of FIG. 2a taken along the line A-A′;

FIG. 3a is a cross-sectional view showing another embodiment of the lateral pipe lining material;

FIG. 3b is a cross-sectional view of the lateral pipe lining material of FIG. 3a taken along the line B-B′;

FIG. 4 is a side view showing still another embodiment of the lateral pipe lining material;

FIG. 5a is a cross-sectional view of the lateral pipe lining material of FIG. 4 taken along the line C-C′;

FIG. 5b is a cross-sectional view of the lateral pipe lining material of FIG. 4 taken along the line D-D′;

FIG. 5c is a cross-sectional view of the lateral pipe lining material of FIG. 4 taken along the line E-E′;

FIG. 6 is a side view showing expanded part of the lateral pipe lining material of FIG. 4;

FIG. 7 is a perspective view showing a pushing-up member attached to the lateral pipe lining material;

FIG. 8 is a perspective view showing a lifting apparatus used in the present invention;

FIG. 9 is a perspective view showing a state where the lateral pipe lining material is lifted by the lifting apparatus of FIG. 8;

FIG. 10a is a top view showing a state where a collar of the lateral pipe lining material is brought into close contact with a main pipe by a pushing-up member;

FIG. 10b is a longitudinal sectional view showing the above state of FIG. 10a;

FIG. 11 is a perspective view showing the lateral pipe lining material housed in a plastic bag according to the embodiment of the present invention;

FIG. 12 is a perspective view showing a carrying ship to convey the lateral pipe lining material in the main pipe;

FIG. 13 is a cross-sectional view showing a state where the lateral pipe lining material held by a holding steel belt is drawn into the lateral pipe;

FIG. 14 is a cross-sectional view showing the state where the invasion of the resin of the main pipe lining material is prevented when the main pipe is lined after the lateral pipe has been lined; and

FIG. 15 is a cross-sectional view showing a process in which wrinkles in a resin impregnated in a tubular resin-absorbing material of the lateral pipe liner are pressed out.

### DESCRIPTION OF THE PREFERRED EMBODIMENTS

Best modes of carrying out the present invention will be described in more detail using various embodiments with reference to the accompanying drawings.

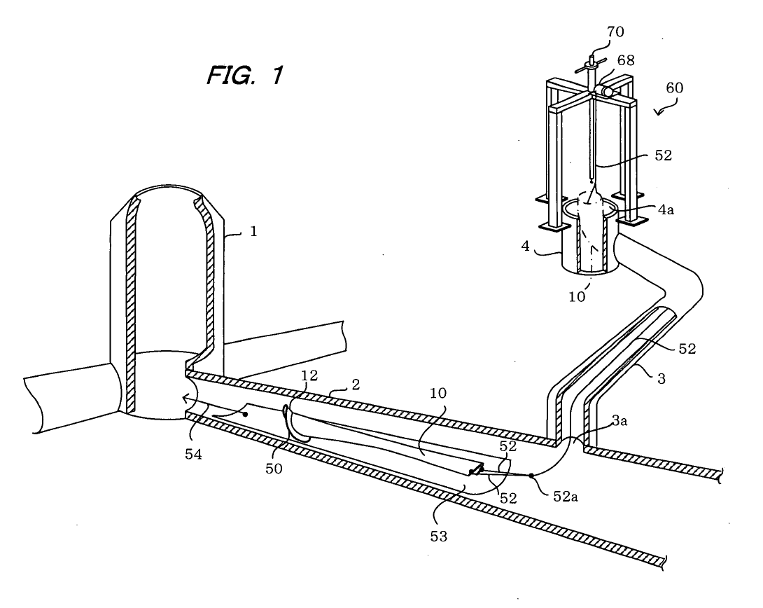

FIG. 1 is an illustrative view showing the state where a lateral pipe lining material 10 carried into a main pipe 2 from a manhole 1 is drawn into a lateral pipe 3 according to an embodiment of the present invention.

A lifting apparatus 60 disposed on the ground is used to wind up a drawing rope 52 which is attached to an end of the lateral pipe lining material 10 in order to lift and draw the lateral pipe lining material 10 into the lateral pipe 3 through a box 4 above the ground. In FIG. 1, the lateral pipe lining material 10 lifted above the ground is shown imaginarily by a dash and dotted line.

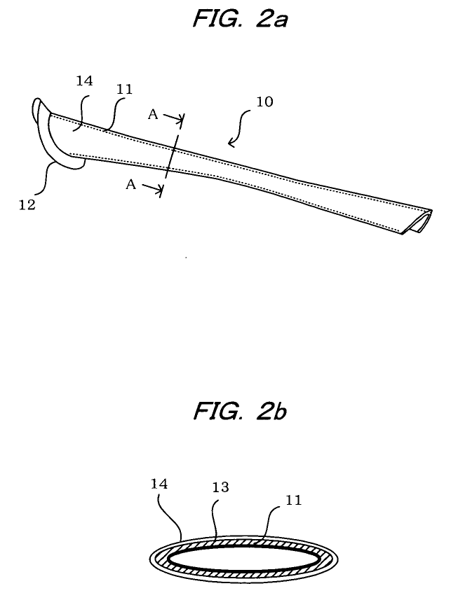

The lateral pipe lining material 10, as shown in FIGS. 2a and 2b, is comprised of a flexible tubular resin-absorbing material 11 of a non-woven fabric. The lining material 10 has a flange-like collar 12 attached at its one end and is made open at the other end thereof. A portion other than the collar 12 of the tubular resin-absorbing material 11 is impregnated with an uncured liquid thermosetting resin. The inner circumferential surface of the tubular resin-absorbing material 11 is coated with a highly airtight plastic film 13 and the outer circumferential surface thereof is covered with a flexible external tube 14, which serves to protect the outer circumferential surface of the resin-absorbing material 11.

Polyester, polypropylene, nylon, acrylic, vinylon, or the like is used for the non-woven fabric tubular resin-absorbing material 11, and an unsaturated polyester resin, epoxy resin, or the like is used for the thermosetting resin impregnated in the resin-absorbing material 11. Polyurethane, polyethylene/nylon copolymer, vinyl chloride, or the like is used for the material for the plastic film 13 and external tube 14.

The collar 12 formed at one end of the tubular resin-absorbing material 11 constitutes a curved surface having the same curvature as the main pipe 2 and its outer diameter is set to be larger than the inner diameter of an opening of the lateral pipe 3. The collar 12 is impregnated with a thermosetting resin, which is cured in advance into a solid state in order to fix the collar 12 to the tubular resin-absorbing material 11.

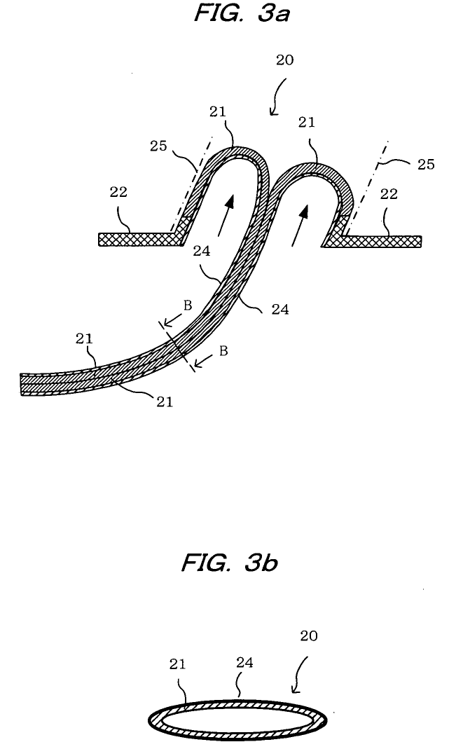

A lateral pipe lining material 20 as shown in FIGS. 3a and 3b is a liner of the type that is everted, i.e. turned inside out. The lateral pipe lining material 20 comprises a tubular resin-absorbing material 21 that has a collar 22 at one end and is opened at the other end thereof. A portion other than the collar 22 of the tubular resin-absorbing material 21 is impregnated with an uncured liquid thermosetting resin, and the outer circumferential surface (which is turned inside out and becomes the inner circumferential surface when the tubular resin-absorbing material 21 is everted) of the above portion is coated with highly airtight plastic film 24. Both the tubular resin-absorbing material 21 and tubular resin-absorbing material 11 are made of the same material and both the plastic film 24 and plastic film 13 are made of the same material. Both the collar 22 and collar 12 in which the thermosetting resin impregnated therein is cured in advance have the same shape and are fixed to the tubular resin-absorbing material 21 and 11. As shown in FIG. 3a, the lateral pipe lining material 20 is everted when fluid pressure is applied thereto. If the tubular resin-absorbing material 21 is everted and inserted into a peelable external tube 25 that is of the same material as the external tube 14, then the lateral pipe lining material 20 has the same configuration as the lateral pipe lining material 10 as shown in FIGS. 2a and 2b.

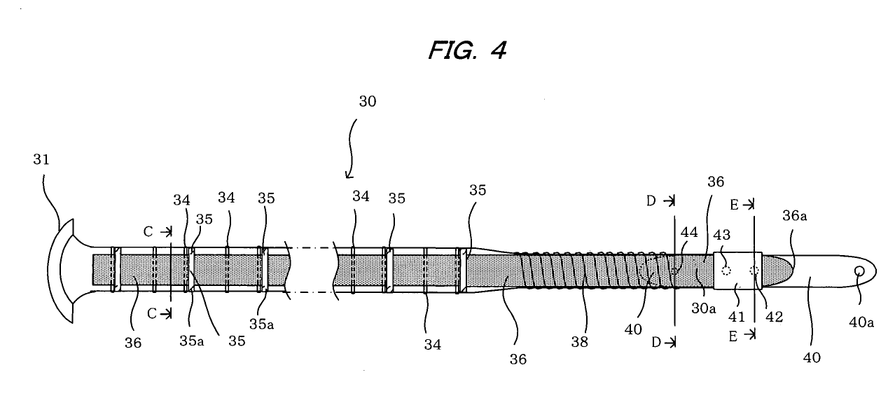

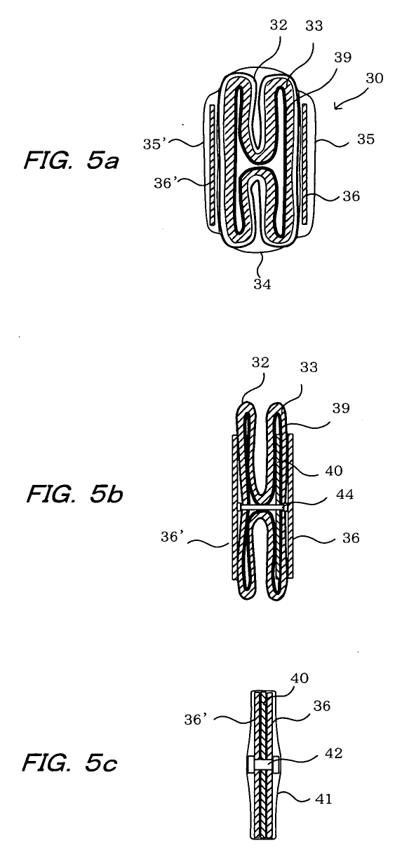

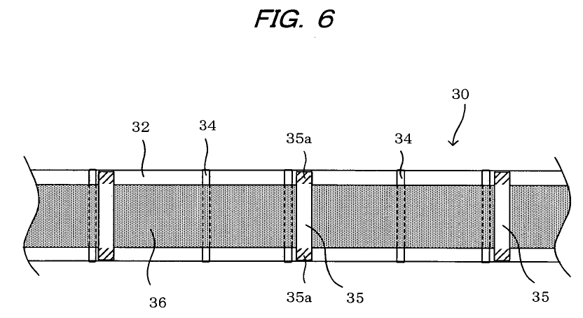

In FIG. 4, FIGS. 5a, 5b, and 5c, and FIG. 6, another lateral pipe lining material 30 are shown that is drawn into the lateral pipe.

The lateral pipe lining material 30 is comprised of a tubular resin absorbing material 33 which is composed of the same material as the tubular resin absorbing materials 11 and 21 and is impregnated with a liquid uncured thermosetting resin. Its outer circumferential surface is covered with the same peelable external tube 32 as the external tubes 14 and 25. Also, its inner circumferential surface is coated with the same highly airtight plastic film 39 as the plastic films 13 and 24. The tubular resin-absorbing material 33 is provided at one end with a collar 31 and is opened at the other end thereof. The collar 31 has the same configuration as the collars 12 and 22, and is impregnated with the thermosetting resin, which is cured in advance into a solid state in order to fix the collar 31 to the tubular resin-absorbing material 33.

The lateral pipe lining material 30 fabricated as above has the same configuration as the lateral pipe lining material 20 shown in FIGS. 2a and 2b and is folded up so as to reduce its outer diameter and have a shape of, for example, H (see FIG. 5a). That is, the lateral pipe lining material 30 first has the same cross section as shown in FIG. 2b. The lateral pipe lining material 30 is then pushed partially from right and left and is folded up so as to have the shape of H as shown in FIG. 5a.

The lateral pipe lining material folded up as above is tied with a tape 34 of cellophane or the like at a predetermined interval to maintain the folded-up shape. Belt loops 35 and 35′ composed of a film such as polyethylene are attached to both sides of the folded-up lateral pipe lining material 30 at an appropriate interval. These belt loops 35 and 35′ are attached by bonding both ends of the belt loops 35 and 35′ to the external tube 32. Into both the belt loops 35 and 35′ are inserted holding steel belts 36 and 36′ that are made of the material imparting elasticity and rigidity so that the lateral pipe lining material 30 may be maintained so as to have elasticity and rigidity.

The end portion 30a of the lateral pipe lining material 30, as shown in FIGS. 4 and 5b, is coupled via a coupling tool 44 to one end of a guiding steel belt 40 that has elasticity and rigidity to guide the lateral pipe lining material 30 into the lateral pipe. At the other end of the guiding steel belt 40 is formed a hole 40a to which the drawing-in rope 52 is attached. The end portion 36a of the holding steel belts 36 and 36′ extends further over the end portion 30a of the lateral pipe lining material 30 up to a central portion of the guiding steel belt 40, and is secured to the central portion thereof using a coupling tool such as rivets 42 and 43 (see FIG. 5c). The rivets 42 and 43 are covered with a tape 41 made of a plastic having a smooth surface in order to prevent no smooth drawing caused by the touch of the rivets 42 and 43 with the lateral pipe when the lateral pipe lining material 30 is drawn into the lateral pipe. The guiding steel belt 40 is coupled to the holding steel belts 36 and 36′ by the rivets 42 and 43. This prevents elasticity from being reduced in the coupling portion, which may occur in the case of coupling by welding.

The holding steel belts 36 and 36′ are tied to each other with a strong thread 38 at the end of the lateral pipe lining material 30 and are secured thereto so that the lateral pipe lining material 30 and holding steel belts 36 and 36′ are not separated from one another.

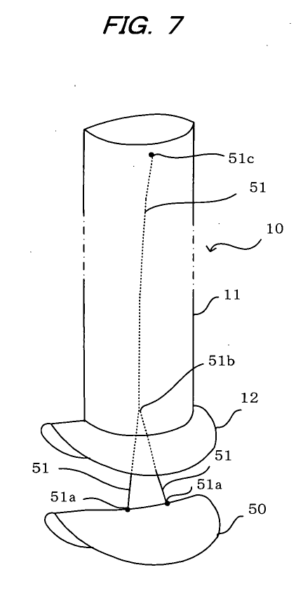

A pushing-up member 50, as shown in FIG. 7, is attached to the lateral pipe lining material (in any one of the materials 10, 20, and 30) in order to bring the collar of the lateral pipe lining material into close contact with a peripheral region of the lateral pipe opening 3a at which the lateral pipe communicates with the main pipe. The pushing-up member 50 pushes up the collar of the lateral pipe lining material when the lateral pipe lining material is drawn into the lateral pipe to the extent that its collar reaches the lateral pipe opening 3a.

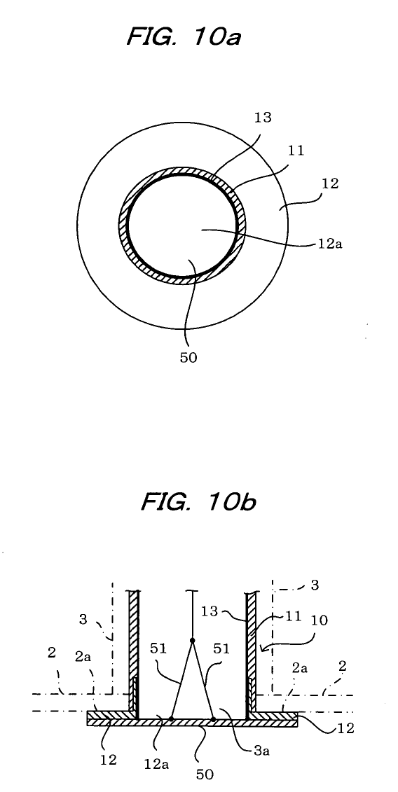

The pushing-up member 50 is made of a plastic or a metal such as a stainless steel and has a size and shape that enable the end portion on the collar side of the lateral pipe lining material 10 to be hermetically or watertightly sealed when the pushing-up member 50 comes into close contact with the collar 12 (FIG. 10b). The example of the pushing-up member 50 shown in FIG. 7 has the same shape and size as the curved collar 12 of the lateral pipe lining material 10.

The pushing-up member 50 is detachably attached to the lateral pipe lining material 10 by securing the branching ends 51a of a lifting rope 51 to the pushing-up member 50 and the other end 51c thereof to a portion of the lateral lining material 10. The pushing-up member 50 is attached so as to come into close contact with the collar 12 of the lateral pipe lining material 10. In FIG. 7, however, the pushing-up member 50 is shown as being separated from the collar 12 of the lateral pipe lining material 10 in order to make clear what the pushing-up member 50 looks like.

Such a pushing-up member can also be applied to the collar 22 of the lateral pipe lining material 20 shown in FIGS. 3a and 3b and to the collar 31 of the lateral pipe lining material 30 shown in FIG. 4. The pushing-up member 50 has such a shape and material that it pushes up the collar of the lateral pipe lining material and comes into close contact therewith to seal the collar opening of the lateral pipe lining material.

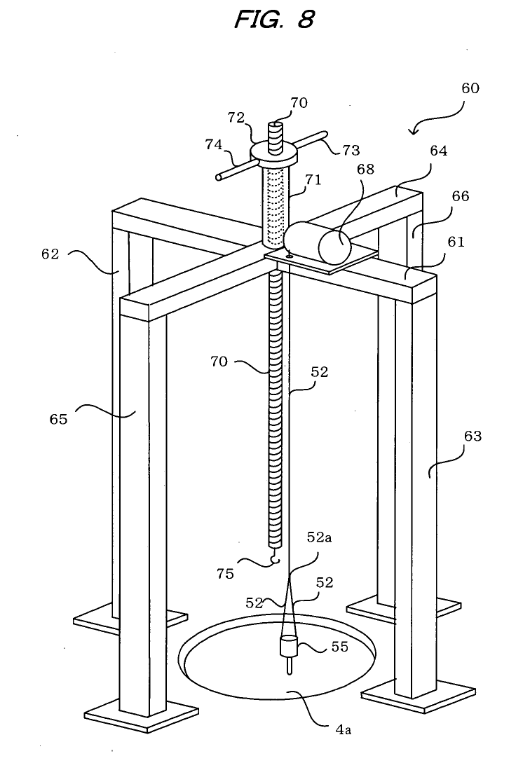

FIG. 8 shows a lifting apparatus 60 for lifting the lateral pipe lining material 10 and pushing-up member 50. The lifting apparatus 60 is placed above ground and comprises columns 62 and 63 to support a beam 61 and columns 65 and 66 to support a beam 64. A winch 68 is attached to the beam 61. A drawing rope 52 having a floating body 55 such as a float or balloon is wound around one end of the winch 68. The floating body 55 is guided from the box 4 through the lateral pipe 3 and main pipe 2 to a manhole 1 and is used to bind the drawing rope 52 on an end of the lateral pipe lining material 10 inserted into the manhole 1.

A screw rod 70 with a hook 75 at one end is attached to the beam 64 of the lifting apparatus 60. The screw rod 70 is screwed into a disk 72 secured to a cylinder 71 and passes through the cylinder 71 and the beam 64. The disk 72 is provided with handles 73 and 74, which are operated to rotate the disk 72 and cylinder 71 and move the screw rod 70 up and down. As described later, the push-up member 50 can be lifted by hooking the lifting rope 51 on the hook 75 of the screw rod 70.

Next, a method for repairing the lateral pipe will be described in which the lateral pipe lining material as described above is drawn into the lateral pipe. In the description below, it is supposed that the main pipe 2 has been lined by using a main pipe lining material and a portion of the main pipe lining material corresponding to the opening 3a of the lateral pipe has been removed and made open.

First, the lateral pipe lining material 10 having the pushing-up member 50 as described above is carried into the manhole 1. Then, as shown in FIG. 8, the drawing rope 52 having the floating body 55 is unwound from the winch 68 of the lifting apparatus 60 to introduce the floating body 55 into the main pipe 2 via the box 4 and the lateral pipe 3. The floating body 55 reaches the manhole 1 by sewage flowing through the main pipe 2, and is detached in the manhole 1 from the drawing pope 52. Instead, the drawing rope 52 is attached to the end of the lateral pipe lining material 10 that is opposite to the collar 12 thereof.

A slip sheet 53 is then laid and spread in the main pipe 2 to lay thereon the lateral pipe lining material 10. The drawing rope 52 is wound up by the winch 68. The lateral pipe lining material 10 smoothly moves on the slip sheet 53 in the main pipe 2 when it is pulled by the rope 52. The lateral pipe lining material 10 is inserted into the lateral pipe 3 when its end reaches the opening 3a thereof. The end of the lateral pipe lining material 10 is folded into two in advance and reduced in diameter so that the lateral pipe lining material 10 can be inserted smoothly into the opening 3a of the lateral pipe 3.

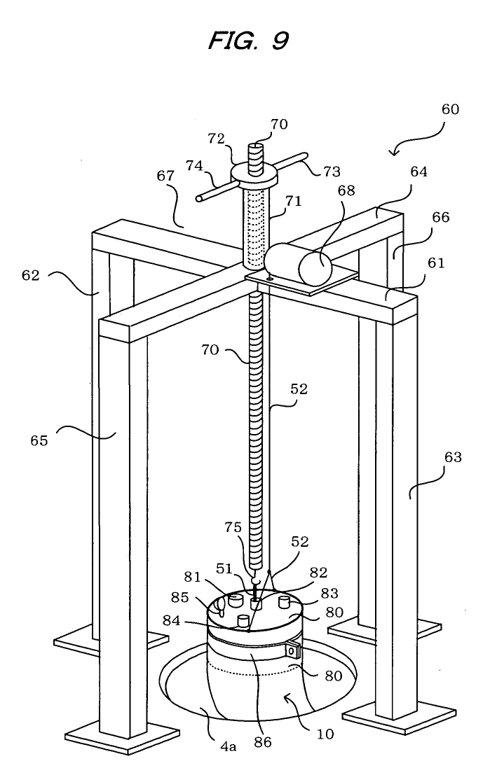

The drawing rope 52 continues to be wound up using the winch 68. This causes the lateral pipe lining material 10 to pass through the lateral pipe and appear from an opening 4a of the box 4, as shown in FIG. 9.

After the lateral pipe lining material 10 is drawn out from the box, the end of the lateral pipe lining material 10 is made open. Prepared is an end cap 80 that is provided with a hot water injecting port 81, a rope drawing port 82, an air exhaust port 83, an air supply port 84, and a thermometer 85. As shown in FIG. 7, the lifting rope 51 that binds the pushing-up member 50 is attached at the other end 51c to the open end of the lateral pipe lining material 10. The lifting rope 51 is detached from the lateral pipe lining material 10 and drawn out of the rope drawing port 82. Then, the end cap 80 is inserted into the open end of the lateral pipe lining material 10 and secured thereto using a clamp 86.

Then, the lifting rope 51 drawn from the rope drawing port 82 is hung on the hook 75 of the screw rod 70 and the handles 73 and 74 are manipulated to lift the screw rod 70. The lifting of the screw rod 70 causes the pushing-up member 50 to push up the collar 12 of the lateral pipe lining material 10 and, as shown in FIG. 10b, the collar 12 to be closely contacted with the peripheral portion 2a of the main pipe 2 adjacent to the opening 3a of the lateral pipe 3. The degree of the close contact can be judged by the degree of manipulation of the handles 73 and 74. When the manipulation of the handles 73 and 74 becomes difficult, it is judged that proper close contact is obtained and the manipulation of the handles 73 and 74 are stopped.

After confirming that the collar 12 of the lateral pipe lining material 10 is brought in close contact with the periphery 2a of the lateral pipe opening 3a by the pushing-up operation by the pushing-up member 50, the external tube is peeled off and removed from the lateral pipe lining material 10. Next, a fluid, for example, compressed air is supplied from the air supply port 84 into the lateral pipe lining material 10 to expand the lateral pipe lining material 10. This causes the lateral pipe lining material 10 to be pushed toward the inner circumferential surface of the lateral pipe 3. Then, a heating medium, for example, hot water is supplied.

The supplied hot water is accumulated inside the lateral pipe lining material 10 since an aperture 12a of the collar 12 of the lateral pipe lining material 10 is watertightly sealed (see FIG. 10b). This enables the thermosetting resin impregnated in the tubular resin-absorbing material 11 of the lateral pipe lining material 10 to be cured. After the curing is confirmed, the supply of air is stopped and, at the same time, the air in the lateral pipe lining material 10 is released through the air exhaust port 83. Then, the handles 73 and 74 are manipulated to lower the screw rod 70 and separate the pushing-up member 50 from the collar 12 of the lateral pipe lining material 10. This causes the hot water inside the lateral pipe lining material 10 to be discharged into the main pipe 2. The portions of the lateral pipe lining material 10 extending out of the box 4 are cut off and the pushing-up member 50 is moved to its original position to terminate the process of lining the lateral pipe 3.

The slip sheet 53 laid on the main pipe is returned back to the manhole 1 by a pull-back rope 54.

In the embodiment described above, the slip sheet 53 is used to convey the lateral pipe lining material 10 in the main pipe 2. However, as shown in FIG. 11, the entire lateral pipe lining material 10 is housed in a plastic bag 90. The drawing rope 91 is attached to the plastic bag 90 and wound up by the winch 68 to draw the lateral pipe lining material 10 into the lateral pipe 3. When the lateral pipe lining material 10 is lifted through the box up to the aboveground level, a pull-back rope 92 that is attached to a bottom of the plastic bag 90 is used to separate the bag 90 from the lateral pipe lining material 10 and return the bag 90 into the manhole 1. In the embodiment, the lateral pipe lining material 10 is housed in the plastic bag 90 and carried. This allows the external tube 14 to be omitted which serves to protect the lateral pipe lining material 10.

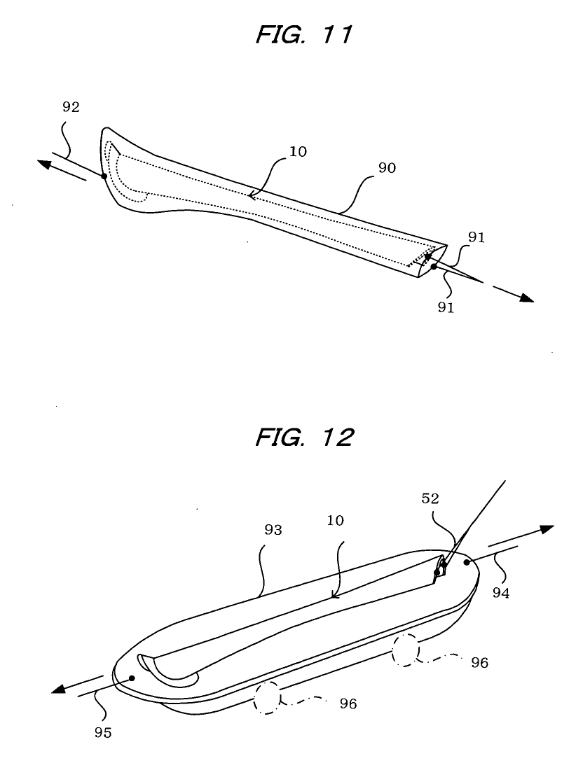

Further, as shown in FIG. 12, a carrying ship 93 in the shape of a bathtub can be used to convey the lateral pipe lining material 10. A towing rope 94 is attached to the end of the lateral pipe lining material 10 and pulled to carry the lateral pipe lining material 10. When the lateral pipe lining material 10 is carried to the lateral pipe opening 3a, the drawing rope 52 attached to the lateral pipe lining material 10 is wound up by the winch 68 in order to draw the lateral pipe lining material 10 into the lateral pipe 3. The carrying ship 93 is returned to the manhole 1 by a pull-back rope 95 that is attached to the back end of the carrying ship 93. The carrying ship 93 may be equipped with wheels 96 as shown by an imaginary line. This allows the material 10 to be conveyed inside the main pipe 2 more smoothly.

As described above, it is understood how the lateral pipe lining material 10 as shown in FIGS. 2a and 2b is drawn in. When the lateral pipe lining material 20 as shown in FIGS. 3a and 3b is to be drawn in, the lateral pipe lining material 20 is everted in advance in the manhole 1 or prior to the insertion of the material 20 into the manhole 1, and the everted lateral pipe lining material 20 is drawn into the lateral pipe 3 in the same manner as described in connection with the lateral pipe lining material 10.

Further, in the case of the lateral pipe lining material 30 as shown in FIG. 4 to FIG. 6, the drawing rope 52 is attached to the hole 40a of the guiding steel belt 40 and wound by the winch 68. This causes the lateral pipe lining material 30 to be drawn through the lateral pipe opening 3a into the lateral pipe 3.

The lateral pipe lining material 30 continues to be drawn in. When the distal end of the lateral pipe lining material 30 passes through the box 4 and appears above the ground, the thread 38 is cut to disconnect the holding steel belts 36 and 36′ from the lateral pipe lining material 30. The lateral pipe lining material 30 is then cut at a portion on the collar side from the coupling tool 44 in order to disconnect the lateral pipe lining material 30 from the guiding steel belt 40. If the guiding steel belt 40 is pulled out, the holding steel belts 36 and 38′ can also be pulled out of the belt loops 35 and 35′ and removed from the lateral pipe lining material 30. The external tube 32 is peeled off in advance.

Then, the end cap 80 is attached to the lateral pipe lining material 30 and compressed air is supplied from the air supply port 84. This causes the tapes 34 to be cut off and the lateral pipe lining material 30 to be expanded against the inner circumferential surface of the lateral pipe 3. Then, as described above, hot water is supplied from the hot water injecting port 81. The pushing-up member 50 brings the collar 31 of the lateral pipe lining material 30 into close contact with the portion 2a of the main pipe 2 adjacent to the opening 3a of the lateral pipe 3 and seals the aperture of the collar 31. This allows the supplied hot water to be accumulated inside the lateral pipe 3 and the thermosetting resin impregnated in the tubular resin absorbing material 33 to be heated and cured.

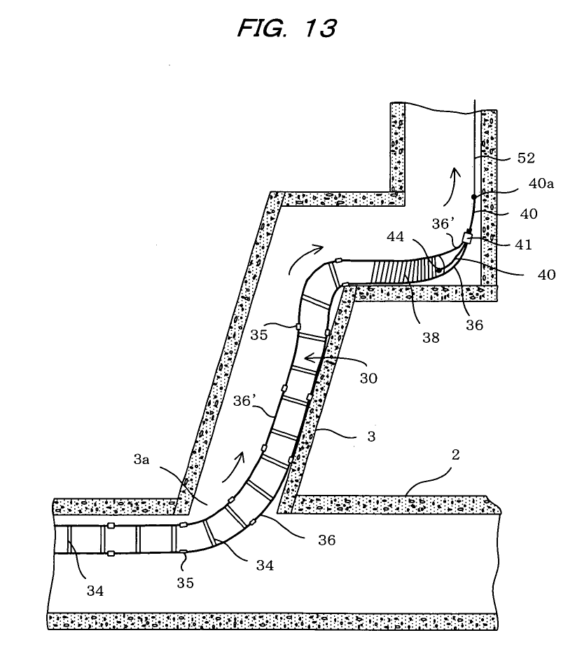

The lateral pipe lining material 30 is guided by the elastic and rigid guiding steel belt 40 and protected by the elastic and rigid holding steel belts 36 and 36′. Consequently, as shown in FIG. 13, even in the case of the lateral pipe having many sections that are bent at a right angle or close to a right angle, the lateral pipe lining material 30 can be inserted into the lateral pipe smoothly, and stretch or damage of the lateral pipe lining material 30 caused by forcible insertion can be prevented. Moreover, the holding steel belts 36 and 36′ protect the lateral pipe lining material 30 while the lateral pipe lining material 30 is being inserted, thereby preventing the damage in the lateral pipe lining material 30. Furthermore, elasticity and rigidity are imparted to the entire lateral pipe lining material 30 by the holding steel belts 36 and 36′. Therefore, the lateral pipe lining material 30 can be drawn into the lateral pipe even by pushing-in of the lateral pipe lining material 30 from the collar 31 side instead of drawing-in by the drawing rope 52.

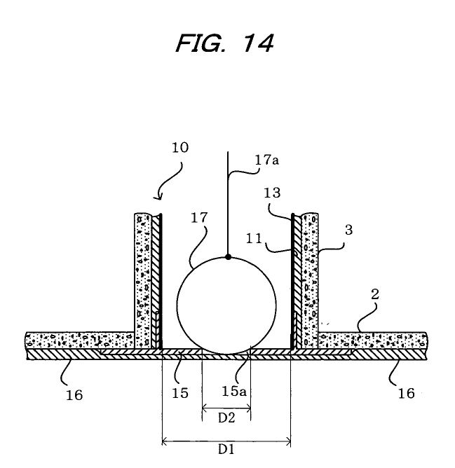

In the above embodiment, the lateral pipe is lined after the main pipe has been lined. When the main pipe is lined after the lateral pipe has been lined, the resin impregnated in the tubular resin absorbing material of the main pipe lining material invades into the lateral pipe 3 through its opening while the main pipe is lined. The example of the prevention of the invasion is shown in FIG. 14.

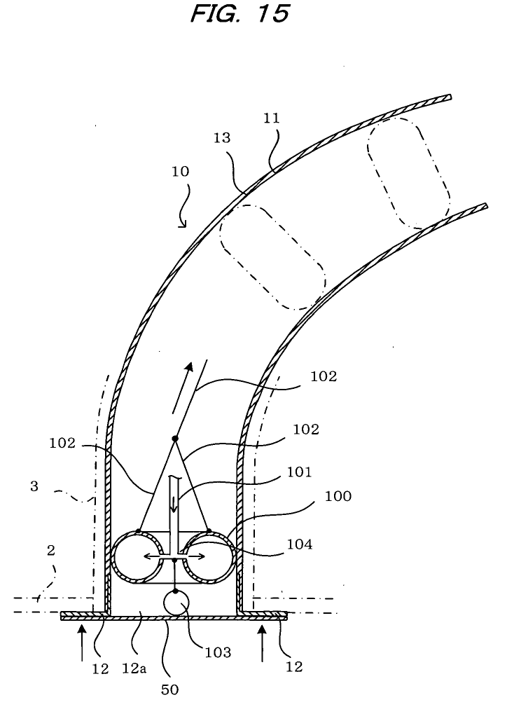

A collar 15 as shown in FIG. 15 is used for the case where the main pipe is lined after the lateral pipe is lined. The collar 15 has at the center a circular aperture 15a of a diameter D2 that is smaller than the diameter D1 of the lateral pipe 3.

After the lateral pipe 3 has been lined, a sphere 17 or flat plate of stainless, hard rubber, or the like, to which a rope 17a is attached, is inserted into the aperture 15a of the collar 15. The sphere 17 serves to prevent the resin impregnated in the main pipe lining material from invading into the lateral pipe while the main pipe is being lined.

To line the main pipe 2, a main pipe lining material 16 is everted and inserted without a start liner into the main pipe 2 from the manhole 1. Thereafter, compressed air is supplied to the main pipe lining material 16 for expansion against the inner circumferential surface of the main pipe 2, and heating medium is supplied into the main pipe to cure the main pipe lining material 16. At this time, the aperture 15a of the collar 15 of the lateral pipe lining material 10 is hermetically sealed by the sphere 7, which prevents the invasion of the thermosetting resin impregnated in the tubular resin absorbing material of the main pipe lining material 16 through the aperture 15a into the lateral pipe 3, thereby making it possible to provide a uniform lining to the main pipe 2.

After the completion of the lining of the main pipe, the sphere 7 is lifted using the rope 17, and a cutter is used to cut off a portion corresponding to the diameter D1 of the collar 15 and the main pipe lining material 16.

If the lateral pipe bends, wrinkles may be generated in the resin impregnated in the tubular resin absorbing material of the drawn lateral pipe lining material. This causes the distribution of the resin not to be uniform and smooth lining not to be guaranteed. Therefore, a tool 100, as shown in FIG. 15, is used to press out wrinkles.

The wrinkle pressing-out tool 100 is made of a material such as rubber which is expandable so as to have a shape of a bladder. A hose 101 extends from the ground to a central space portion 104 of the wrinkle pressing-out tool 100 where the hose 101 further extends horizontally and is connected to the wrinkle pressing-out tool 100. The wrinkle pressing-out tool 100 is expanded so as to have a shape of a bladder when compressed air is supplied thereto. A weight 103 is attached to a lower portion of the hose 101 and one end of the rope 102 is attached to an upper portion of the wrinkle pressing-out tool 100. The other end of the rope 102 is pulled above ground to lift the wrinkle pressing-out tool 100 in the lateral pipe against a load of the weight 103.

As described above, the lateral pipe lining material 10 is drawn into the lateral pipe 3 and expanded by compressed air supplied from the air supply port 84. At this time, the lining material is caused to be bent in accordance with a curve of the lateral pipe 3 and pushed against the inner circumferential surface of the lateral pipe. Since the aperture 12a of the collar 12 of the lateral pipe lining material 10 is sealed, the hot water, which is supplied from the hot water supplying port 81, is accumulated inside the lateral pipe lining material 10. Thus, curing of the resin impregnated in the tubular resin absorbing material 11 starts. As shown by the arrow in FIG. 15, a lifting robot (not shown) is used to force the pushing-up member 50 against the collar 12 in order to seal the aperture 12a thereof.

While the resin impregnated in the tubular resin absorbing material 11 is being cured, the wrinkle pressing-out tool 100 is inserted into an end on the side opposite to the collar 12 of the lateral pipe lining material 10. Since the weight 103 is attached to the lower end of the wrinkle pressing-out tool 100, the wrinkle pressing-out tool 100 is inserted to the lower end of the lateral pipe lining material 10. The horse 101 is connected to the air supply port 84 and compressed air is supplied through the horse 101 to the wrinkle pressing-out tool 100. This causes the wrinkle pressing-out tool 100 to be so expanded as to have a shape of a bladder and to be pushed against the inner circumferential surface of the tubular resin-absorbing material 11 coated with the plastic film 13. At this time, the supply of the compressed air is adjusted so that the outer diameter of the wrinkle pressing-out tool 100 expanded so as to have the shape of the bladder is approximately equal to the inner diameter of the lateral pipe lining material 10.

Thus, the wrinkle pressing-out tool 100 is pushed against the tubular resin-absorbing material 11 of the lateral pipe lining material 10. The wrinkle pressing-out tool 100 is then lifted by the rope 102 from the aboveground position. Since the wrinkle pressing-out tool 100 has the shape of the bladder so as to be uniformly contacted with the inner circumferential surface of the tubular resin-absorbing material 11, the wrinkles are pressed out as the tool 100 is lifted, and the inner circumferential surface of the lateral pipe lining material 10 becomes a uniform surface without any unevenness even if wrinkles occur in the resin impregnated in the tubular resin-absorbing material 11, thus enabling uniform and smooth lining to be performed on the lateral pipe. Moreover, when the wrinkle pressing-out tool 100 is lifted, the hot water accumulated in the lateral pipe lining material 10 is forced to flow through the central space portion 104 of the tool 100 downward. Therefore, the hot water doesn't disturb the lifting of the wrinkle pressing-out tool 100.

The lateral pipe lining materials 10, 20, and 30 shown in FIGS. 2a and 2b, FIGS. 3a and 3b, and FIG. 4 are described as having the collars 12, 22, and 31, whose thermosetting resins impregnated therein are cured at the time of delivery. However, the thermosetting resin may be kept in a liquid state when the lateral pipe lining material is drawn into the lateral pipe. In this case, the collars 12, 22, and 31 are not yet cured and remain flexible, so that they can be brought into close contact with the lateral pipe opening periphery 2a of the main pipe 2. The resins in the collars 12, 22, and 31 may be cured at the same time when the resins of the tubular resin-absorbing materials 11, 21, and 33 are cured.

It is apparent that the present invention is not limited to the above embodiments but may be changed and modified without departing from the scope and spirit of the invention.

What is claimed is:

1. A lateral pipe lining material for repairing a lateral pipe having an opening at a location where the lateral pipe communicates with a main pipe, the lateral pipe lining material being inserted into the lateral pipe in order to repair the lateral pipe comprising:
a tubular resin-absorbing material that is impregnated with a setting resin;
a collar formed at an end of the tubular resin-absorbing material; and
a pushing-up member for pushing up the collar so as to come into close contact with a lateral pipe opening periphery of the main pipe when the lateral pipe lining material is inserted into the lateral pipe.

2. A lateral pipe lining material according to claim 1, wherein the pushing-up member has the same shape as the collar of the lateral pipe lining material.

3. A lateral pipe lining material according to claim 1, wherein the pushing-up member is removably attached to the lateral pipe lining material.

4. A lateral pipe lining material according to claim 1, wherein the pushing-up member is attached so as to come into close contact with the collar of the lateral pipe lining material.

5. A lateral pipe lining material according to claim 1, wherein the lateral pipe lining material is held by a member having elasticity and rigidity.

6. A lateral pipe lining material according to claim 1, wherein the lateral pipe lining material is coupled to a member having elasticity and rigidity and guided by the member into the lateral pipe.

7. A lateral pipe lining material according to claim 5, wherein the member having elasticity and rigidity is a steel belt.

8. A lateral pipe lining material according to claim 5, wherein the lateral pipe lining material is folded into an H shape and held by the member having elasticity and rigidity.

9. A lateral pipe lining method for lining a lateral pipe in which a tubular lateral pipe lining material having a collar formed at an end of a tubular resin-absorbing material impregnated with a setting resin is inserted through a main pipe into the lateral pipe via an opening of the lateral pipe at which the lateral pipe communicates with the main pipe, comprising the steps of:
attaching to the lateral pipe lining material a pushing-up member for pushing up the collar of the lateral pipe lining material;
drawing the lateral pipe lining material from an aboveground position into the main pipe using a drawing rope;
lifting the pushing-up member in the aboveground direction to bring the collar of the lateral pipe lining material into close contact with a lateral pipe opening periphery of the main pipe when the lateral pipe lining material is drawn into the lateral pipe to the extent that the collar thereof reaches the lateral pipe opening periphery of the main pipe;
expanding the lateral pipe lining material against the inner circumferential surface of the lateral pipe, the collar of the lateral pipe lining material being in close contact with the lateral pipe opening periphery of the main pipe by means of the pushing-up member; and
supplying a heating medium to the expanded lateral pipe lining material to cure a resin impregnated in the tubular resin-absorbing material and line the lateral pipe.

10. A lateral pipe lining method according to claim 9, wherein, after the resin impregnated in the tubular resin-absorbing material has been cured, the pushing-up member is separated from the collar to discharge the heating medium accumulated in the lateral pipe lining material into the main pipe.

11. A lateral pipe lining method according to claim 9, wherein the lateral pipe lining material is conveyed through the main pipe to the lateral pipe on a slip sheet that is laid in the main pipe.

12. A lateral pipe lining method according to claim 9, wherein the lateral pipe lining material is housed in a bag and conveyed through the main pipe to the lateral pipe.

13. A lateral pipe lining method according to claim 9, wherein the lateral pipe lining material is conveyed through the main pipe to the lateral pipe by means of a carrying ship having wheels or no wheels.

14. A lateral pipe lining method according to claim 9, wherein the lateral pipe lining material is held by a member having elasticity and rigidity and conveyed through the main pipe into the lateral pipe.

15. A lateral pipe lining method according to claim 9, wherein the lateral pipe lining material is coupled to a member having elasticity and rigidity and guided by the member into the main pipe or the lateral pipe.

16. A lateral pipe lining method according to claim 15, wherein the lateral pipe lining material is folded into an H shape and held by the member having elasticity and rigidity.

17. A lateral pipe lining method according to claim 14 or 15, wherein the member having elasticity and rigidity is a steel belt.

18. A lateral pipe lining method according to claim 9, wherein, after the lateral pipe has been lined, the main pipe is lined using a main pipe lining material, and a resin impregnated in the main pipe lining material is prevented from invading into the lateral pipe while the main pipe is being lined.

19. A lateral pipe lining method according to claim 9, further comprising the steps of:
inserting an expandable wrinkle pressing-out tool into the lateral pipe lining material before the resin impregnated in the tubular resin absorbing material has been cured completely;
expanding the wrinkle pressing-out tool against the tubular resin absorbing material; and
moving the wrinkle pressing-out tool to remove wrinkles occurring in the resin impregnated in the tubular resin-absorbing material.

20. A lateral pipe lining method according to claim 19, wherein a weight is attached to a lower end of the wrinkle pressing-out tool.

21. A lateral pipe lining method for lining a lateral pipe in which a tubular lateral pipe lining material having a collar formed at an end of a tubular resin-absorbing material impregnated with a setting resin is inserted through a main pipe into the lateral pipe via an opening of the lateral pipe at which the lateral pipe communicates with the main pipe, comprising the steps of:
drawing the lateral pipe lining material into the lateral pipe from an aboveground position using a drawing rope;
sealing the aperture of the collar of the lateral pipe lining material when it is drawn into the lateral pipe to the extent that the collar of the lateral pipe lining material comes into close contact with the lateral pipe opening periphery of the main pipe;
expanding the lateral pipe lining material against the inner circumferential surface of the lateral pipe and supplying a heating medium in the expanded lateral pipe lining material to start curing the resin impregnated therein;
inserting an expandable wrinkle pressing-out tool into the lateral pipe lining material before the resin impregnated in the lateral pipe lining material has been cured completely;
expanding the wrinkle pressing-out tool against the tubular resin-absorbing material; and
moving the wrinkle pressing-out tool to press out wrinkles in the resin and line the lateral pipe.

22. A lateral pipe lining method according to claim 21, wherein a weight is attached to a lower end of the wrinkle pressing-out tool.
